(19) United States
(12) Patent Application Publication
(10) Pub. No.: US 2026/0153442 A1
(43) Pub. Date: Jun. 4, 2026

(54) FLUORESCENCE DETECTION DEVICE AND FLUORESCENCE DETECTION DEVICE PLATE

(71) Applicant: SONY SEMICONDUCTOR SOLUTIONS CORPORATION, KANAGAWA (JP)

(72) Inventors: TOMOHIKO BABA, KANAGAWA (JP); NAOKI NISHI, KANAGAWA (JP)

(21) Appl. No.: 19/123,005

(22) PCT Filed: Sep. 15, 2023
(86) PCT No.: PCT/JP2023/033772

§ 371 Date: Apr. 21, 2025

(30) Foreign Application Priority Data
Oct. 26, 2022 (JP) 2022-171191

(51) Int. Cl. G01N 21/64

(52) U.S. Cl. CPC G01N 21/6452; G01N 21/6456; G01N 2021/6471; G01N 2021/6478

(57) ABSTRACT

Provided is a fluorescence detection device with high light use efficiency. The fluorescence detection device according to the present technology detects fluorescence of the test object, the fluorescence being generated by irradiation with excitation light. The fluorescence detection device includes: a micro-well array layer having, on an upper surface, micro-wells in a two-dimensional array shape capable of accommodating the test object; a first detection mechanism provided, below the micro-well array layer, corresponding to each of the micro-wells; and a solid-state imaging element provided, below the first detection mechanism, corresponding to each of the first detection mechanisms, in which the first detection mechanism includes a first microlens group having positive power.

### TECHNICAL FIELD

The present technology relates to a fluorescence detection device and a fluorescence detection device plate.

### BACKGROUND ART

Conventionally, various techniques for applying excitation light to a sample (for example, a biological sample) and detecting fluorescence emitted from the sample have been proposed. In the technique, microscopes are widely used as means for observing fluorescence.

Meanwhile, a technique for detecting fluorescence without using a microscope has also been proposed. For example, the following Patent Document 1 discloses a biosensor configured to detect fluorescence of a sample with a semiconductor imaging element.

### CITATION LIST

### Patent Document

Patent Document 1: Japanese Translation of PCT International Application Publication No. 2020-525760

### SUMMARY OF THE INVENTION

### Problems to be Solved by the Invention

It is considered that the fluorescence of the sample can be detected by using the technique described in Patent Document 1.

However, it cannot be said that the light use efficiency in the technique described in Patent Document 1 is sufficiently high, and there is room for improvement.

A main object of the present technology is to provide a fluorescence detection device having high light use efficiency.

### Solutions to Problems

The present technology provides
a fluorescence detection device that detects fluorescence of a test object, the fluorescence being generated by irradiation with excitation light, the fluorescence detection device including:
a micro-well array layer having, on an upper surface, micro-wells in a two-dimensional array shape capable of accommodating the test object;
a first detection mechanism provided, below the micro-well array layer, corresponding to each of the micro-wells; and
a solid-state imaging element provided, below the first detection mechanism, corresponding to each of the first detection mechanisms, in which
the first detection mechanism includes a first microlens group having positive power.

The first detection mechanism may include, in order from the micro-well side, the first microlens group having positive power and the optical filter that transmits the fluorescence.

The excitation light may be obliquely applied to the upper surface of the micro-well array layer.

The fluorescence detection device may further include a second detection mechanism provided between the first detection mechanism and the solid-state imaging element, corresponding to each of the first detection mechanisms, and the second detection mechanism may include a second microlens group having positive power.

The second detection mechanism may include, in order from the first detection mechanism side, a second microlens group having positive power and a light shielding film having an opening, and the opening may be arranged corresponding to a focal position of the second microlens group.

The solid-state imaging element may have a light receiving surface of the fluorescence, and the fluorescence having reached the light receiving surface from the micro-well may have an optical axis perpendicular to the light receiving surface.

In the fluorescence detection device, a plurality of combinations of the one second detection mechanism and the one solid-state imaging element arranged in a vertical direction may be arranged in parallel in a horizontal direction, corresponding to one micro-well.

In the fluorescence detection device, an air layer may be provided between the first detection mechanism and the second detection mechanism.

The first microlens group may be configured by a diffractive lens or a metalens. The second microlens group may be configured by a diffractive lens or a metalens. The optical filter may block the excitation light.

The diameter of the opening of the light shielding film may be 0.0003 mm or more and 0.01 mm or less.

A focal length of the second microlens group may be 0.0003 mm or more and 3 mm or less.

The fluorescence detection device may further include a light source that applies the excitation light.

Furthermore, the present technology provides
a fluorescence detection device plate including:
a micro-well array layer having, on an upper surface, micro-wells in a two-dimensional array shape capable of accommodating the test object; and
a first detection mechanism provided, below the micro-well array layer, corresponding to each of the micro-wells, in which
the first detection mechanism includes a first microlens group having positive power.

### BRIEF DESCRIPTION OF DRAWINGS

FIG. 1 is a schematic diagram illustrating a flow of fluorescence detection by a microscope.

FIG. 2 is a schematic diagram illustrating an example of a cross section of a fluorescence detection device according to the present technology.

FIG. 3 is an outline diagram in a plan view of a fluorescence detection device plate.

FIG. 4 is an enlarged diagram in a plan view of a portion illustrated by a broken line in FIG. 3.

FIG. 5 is a schematic diagram illustrating a cross section of a portion of a fluorescence detection device plate.

FIG. 6 is a schematic diagram illustrating a cross section of a micro-well accommodating a test object.

FIG. 7 is a schematic diagram illustrating a cross section of a second detection mechanism.

FIG. 8 is a schematic diagram illustrating light (angle of view of 0°) incident on the second detection mechanism.

FIG. 9 is a schematic diagram illustrating light (angle of view of 10°) incident on the second detection mechanism.

FIG. 10 is a schematic diagram illustrating a solid-state imaging element having silicon (Si) substrate and a second detection mechanism including a light shielding film.

FIG. 11 is a schematic diagram illustrating a cross section of a portion of a fluorescence detection device according to a first embodiment.

FIG. 12 is a schematic diagram illustrating a cross section of a portion of the fluorescence detection device according to the first embodiment.

FIG. 13 is a schematic diagram illustrating a cross section of a portion of the fluorescence detection device according to a modification of the first embodiment.

FIG. 14 is a schematic diagram illustrating a cross section of a portion of the fluorescence detection device according to the modification of the first embodiment.

FIG. 15 is a schematic diagram illustrating a cross section of a portion of a fluorescence detection device according to a second embodiment.

FIG. 16 is a diagram illustrating a result of simulation in a case where an incidence angle of excitation light is 0°.

FIG. 17 is a diagram illustrating a result of simulation in a case where the incidence angle of the excitation light is 30°.

FIG. 18 is a diagram illustrating a result of simulation in a case where the incidence angle of the excitation light is 33°.

FIG. 19 is a schematic diagram illustrating a cross section of a portion of a fluorescence detection device according to a third embodiment.

FIG. 20 is a schematic diagram illustrating a cross section of a portion of the fluorescence detection device according to a modification of the third embodiment.

FIG. 21 is a schematic diagram illustrating an example of the fluorescence detection device according to the modification of the third embodiment.

FIG. 22 is a schematic diagram illustrating a cross section of an example of the fluorescence detection device according to the modification of the third embodiment.

FIG. 23 is a schematic diagram illustrating a cross section of another example of the fluorescence detection device according to the modification of the third embodiment.

FIG. 24 is a schematic diagram illustrating a cross section of an example of a fluorescence detection device.

FIG. 25 is a first diagram for explaining a method for manufacturing the fluorescence detection device.

FIG. 26 is a second diagram for explaining the method for manufacturing the fluorescence detection device.

FIG. 27 is a third diagram for explaining the method for manufacturing the fluorescence detection device.

FIG. 28 is a fourth diagram for explaining the method for manufacturing the fluorescence detection device.

FIG. 29 is a fifth diagram for explaining the method for manufacturing the fluorescence detection device.

FIG. 30 is a sixth diagram for explaining the method for manufacturing the fluorescence detection device.

FIG. 31 is a seventh diagram for explaining the method for manufacturing the fluorescence detection device.

FIG. 32 is an eighth diagram for explaining the method for manufacturing the fluorescence detection device.

FIG. 33 is a ninth diagram for explaining the method for manufacturing the fluorescence detection device.

FIG. 34 is a tenth diagram for explaining the method for manufacturing the fluorescence detection device.

FIG. 35 is an eleventh diagram for explaining the method for manufacturing the fluorescence detection device.

FIG. 36 is a twelfth diagram for explaining the method for manufacturing the fluorescence detection device.

### MODE FOR CARRYING OUT THE INVENTION

Hereinafter, preferred embodiments for carrying out the present technology will be described with reference to the drawings. The embodiments described below illustrate representative embodiments of the present technology, and the scope of the present technology is not limited only to these embodiments. The present technology will be described in the following order.
1. Conventional Fluorescence Detection Method
2. Fluorescence Detection Device of Present Technology
2-1. Outline
2-2. Fluorescence Detection Device Plate
2-2-1. Overall configuration of fluorescence detection device plate
2-2-2. Micro-well array layer
2-2-3. First detection mechanism
2-2-3-1. First microlens group
2-2-3-2. Optical filter
2-3. Second Detection Mechanism
2-3-1. Second microlens group 2-3-2. Light shielding film
2-4. Solid-state Imaging Element
2-5. Light Source
2-6. Other Components
2-7. Test Object
3. Each Embodiment of Fluorescence Detection Device 3-1. First Embodiment
3-1-1. Modification of first embodiment
3-2. Second Embodiment
3-3. Third Embodiment
3-3-1. Modification of third embodiment
4. Method for Manufacturing Fluorescence Detection Device

### 1. Conventional Fluorescence Detection Method

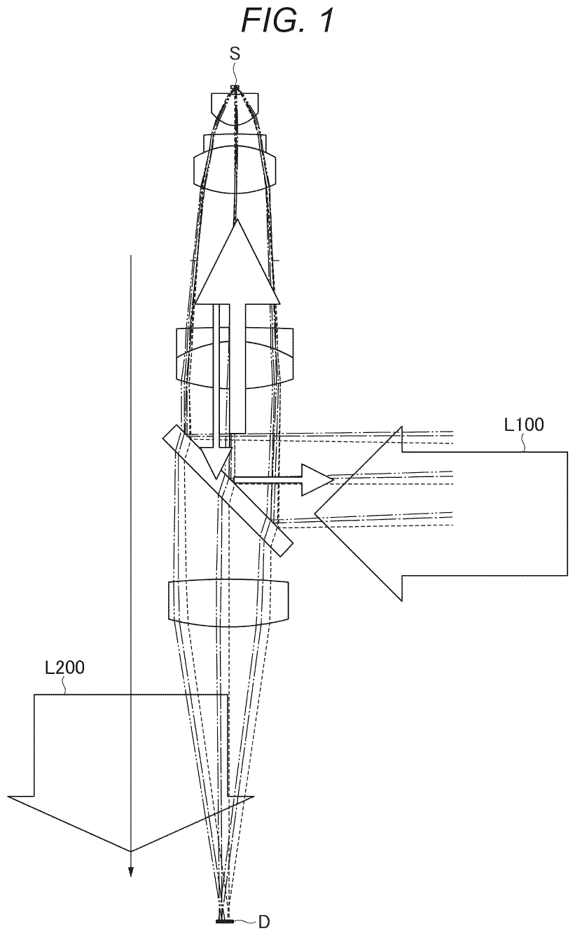

First, a conventional fluorescence detection method using a microscope will be described with reference to FIG. 1. FIG. 1 is a schematic diagram illustrating a flow of fluorescence detection by a microscope.

As illustrated in FIG. 1, excitation light L100 (for example, a wavelength of 480 nm) applied horizontally is reflected by a mirror and directed upward. The excitation light L100 directed upward is applied to a sample S (test object).

Fluorescent molecule in the sample S is excited and fluorescence is radiated. The radiated fluorescence is directed downward passing through the mirror and a filter. Finally, fluorescence L200 (for example, a wavelength of 530 nm) having reached a detection unit D (for example, a sensor) is detected. In a case of observing fluorescence by a microscope, for example, regions (0.2 cm square each) obtained by dividing a 1 cm square region by 5×5 are observed by 25 shots.

In a case of the fluorescence detection method as illustrated in FIG. 1, a field of view at the time of observation is narrow, and it is difficult to simultaneously detect fluorescence emitted from a large number of samples.

In response to this, for example, it is conceivable that the use of the technique disclosed in Patent Document 1 will enable a large number of beams of fluorescence to be simultaneously detected. However, it can be considered that there is room for improvement in the technique described in Patent Document 1 from the viewpoint of light use efficiency as described above.

Next, the present technology will be described.

### 2. Fluorescence Detection Device of Present Technology

### 2-1. Outline

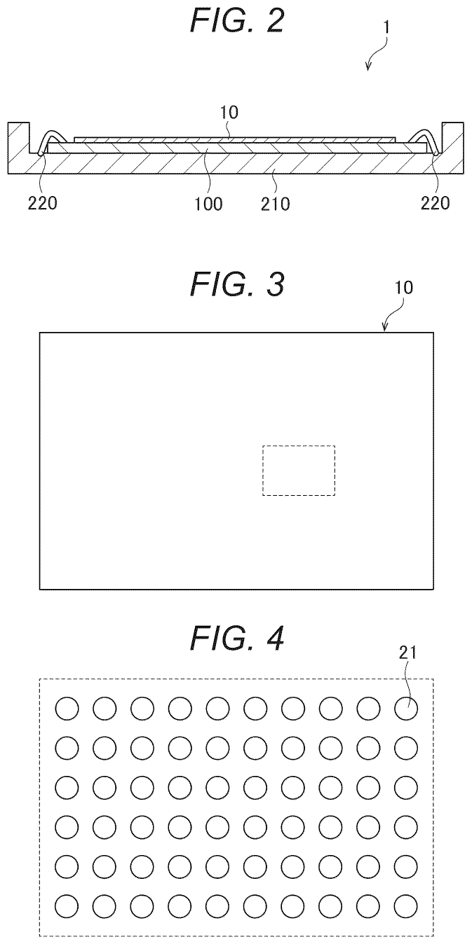

FIG. 2 is a schematic diagram illustrating an example of a cross section of the fluorescence detection device 1 according to the present technology. The fluorescence detection device 1 basically has a configuration in which a fluorescence detection device plate 10 and a solid-state imaging device 100 are arranged vertically.

The fluorescence detection device plate 10 includes a micro-well array layer having micro-wells in a two-dimensional array shape capable of accommodating a test object on the upper surface.

FIG. 3 is an outline diagram in plan view of the fluorescence detection device plate 10. However, in FIG. 3, illustration of the micro-well is omitted. FIG. 4 is an enlarged diagram in plan view of a portion illustrated by a broken line in FIG. 3. As illustrated in FIG. 4, a large number of micro-wells 21 are formed on the upper surface of the fluorescence detection device plate 10. In this manner, the large number of micro-wells 21 are aligned in a two-dimensional array shape.

Although not illustrated, the fluorescence detection device plate 10 further includes a first detection mechanism provided below the micro-well array layer, corresponding to each of the micro-wells 21.

The solid-state imaging device 100 provided below the first detection mechanism includes a solid-state imaging element provided corresponding to each of the first detection mechanisms. The solid-state imaging element detects fluorescence of the test object, the fluorescence being generated by irradiation with excitation light. Specifically, the test object is accommodated in the micro-well 21 and the excitation light is applied to the test object. The test object irradiated with the excitation light generates fluorescence. A part of the fluorescence advances below the fluorescence detection device plate, and is finally detected by the solid-state imaging element. In this way, the fluorescence detection device 1 can simultaneously detect fluorescence of a large number of test objects accommodated in a large number of micro-wells 21.

Furthermore, in the fluorescence detection device 1, a solid-state imaging element having a high light response speed and capable of coping with high-speed recording is used.

Therefore, the fluorescence detection device 1 can instantly detect the fluorescence of the test object.

Next, a configuration of the fluorescence detection device of the present technology will be described in detail.

### 2-2. Fluorescence Detection Device Plate

2-2-1. Overall configuration of fluorescence detection device plate

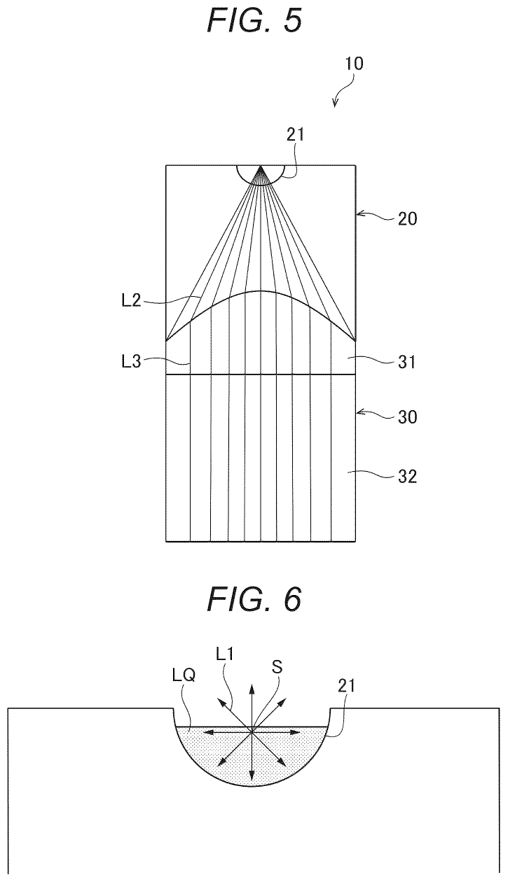

FIG. 5 is a schematic diagram illustrating a cross section of a portion of the fluorescence detection device plate 10.

Specifically, FIG. 5 is a cross section in a thickness direction (direction orthogonal to a plane direction) including one micro-well 21. Note that in a case where a cross section is illustrated in the drawings as described later, the cross section is a cross section in the thickness direction in the Same manner as in FIG. 5.

As illustrated in FIG. 5, in the fluorescence detection device plate 10, one first detection mechanism 30 is provided below one micro-well 21 provided in the micro-well array layer 20. That is, the one micro-well 21 and the one first detection mechanism 30 are arranged vertically.

### 2-2-2. Micro-well Array Layer

The test object is accommodated in the inside of the micro-well 21 provided in the micro-well array layer 20. FIG. 6 is a schematic diagram illustrating a cross section of the micro-well 21 accommodating the test object S. As illustrated in FIG. 6, the test object S is accommodated together with a liquid, such as a sample liquid LQ, for example, in the micro-well 21. The test object S emits the fluorescence L1 in all the directions when receiving irradiation with excitation light.

The shape of the micro-well 21 in plan view may be, for example, a circular shape, but is not limited thereto.

Furthermore, the shape of a bottom surface of the micro-well 21 may be, for example, a U-bottom shape, a round-bottom shape, a flat-bottom shape, and the like, but is not limited thereto.

Note that in the present technology, the portion in which the test object is accommodated is not limited to the micro-wells 21 in a two-dimensional array shape. Thus, in the fluorescence detection device plate 10, the micro-well array layer 20 having, on an upper surface, the micro-wells 21 in a two-dimensional array shape capable of accommodating the test object may be substituted by another instrument. The another instrument is specifically an instrument having a test object accommodating part capable of accommodating a test object, and may be, for example, an instrument having a test object accommodating part in an array shape capable of accommodating a test object. The test object accommodating part in an array shape is in a state in which a plurality of (particularly, a large number of) test object accommodating parts is arranged in an array, and such arrangement enables the plurality of (particularly, a large number of) test objects to be simultaneously detected.

### 2-2-3. First Detection Mechanism

### 2-2-3-1. First Microlens Group

FIG. 5 is referred to again. The first detection mechanism 30 includes a first microlens group 31 having positive power.

In the present specification, the “microlens group” may be configured by one microlens, or may be configured by two or more microlenses. The first microlens group 31 may be configured by a diffractive lens or a metalens, for example.

The first microlens group 31 has a function of making divergent light L2 passing through the micro-well array layer 20 among the fluorescence L1 (see FIG. 6) emitted from the test object S parallel light L3. As illustrated in FIG. 5, the divergent light L2 passes through the micro-well array layer 20 and travels downward toward the first microlens group 31. The first microlens group 31 bends the divergent light L2 to make the divergent light L2 parallel light L3.

The parallel light L3 can reach a light receiving surface (not illustrated) of the solid-state imaging element. Therefore, the parallel light L3 reaching the light receiving surface of the solid-state imaging element from the micro-well 21 has an optical axis perpendicular to the light receiving surface.

Since the fluorescence detection device plate 10 includes the first microlens group 31 having positive power, the fluorescence L1 emitted from the test object S can be efficiently guided to the light receiving surface of the solid-state imaging element. Therefore, the light use efficiency in the fluorescence detection device 1 can be increased.

### 2-2-3-2. Optical Filter

As illustrated in FIG. 5, the first detection mechanism 30 may further include an optical filter that transmits fluorescence. Specifically, the first detection mechanism 30 may include, in order from the micro-well 21 side (the micro-well array layer 20 side), the first microlens group 31 having positive power, and the optical filter 32 that transmits the fluorescence.

The optical filter 32 may be, for example, an optical filter that blocks excitation light, and specifically, may be an optical filter that blocks excitation light and transmits fluorescence. Since the first detection mechanism 30 includes the optical filter 32, it is possible to suppress the excitation light, which is noise, from entering the solid-state imaging element. Therefore, an SN ratio in the fluorescence detection device 1 can be increased.

### 2-3. Second Detection Mechanism

The fluorescence detection device plate 10 may further include a second detection mechanism provided corresponding to each of the first detection mechanisms 30 between the first detection mechanism 30 and the solid-state imaging element. Therefore, the light use efficiency in the fluorescence detection device 1 can be further increased.

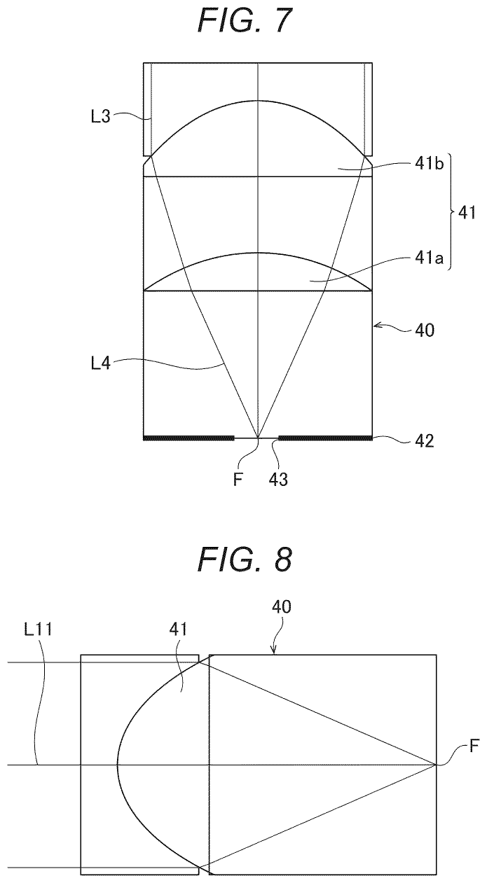

FIG. 7 is a schematic diagram illustrating a cross section of a second detection mechanism 40. In the fluorescence detection device 1, the second detection mechanism 40 illustrated in FIG. 7 is provided below the first detection mechanism 30. Specifically, at least one second detection mechanism 40 is provided below one first detection mechanism 30 illustrated in FIG. 5. That is, the micro-well 21 and the first detection mechanism 30 illustrated in FIG. 5 and the second detection mechanism 30 illustrated in FIG. 7 are arranged vertically. Then, the solid-state imaging element is provided below the second detection mechanism 40.

The number of the second detection mechanisms 40 provided corresponding to one micro-well 21 and one first detection mechanism 30 may be one or more. In a case where the number of the second detection mechanisms 40 is plural, the plurality of second detection mechanisms 40 is arranged in parallel in the horizontal direction (direction orthogonal to the vertical direction).

### 2-3-1. Second Microlens Group

As illustrated in FIG. 7, the second detection mechanism 40 includes the second microlens group 41 having positive power. The second microlens group 41 illustrated in FIG. 7 is configured by two microlenses 41a and 41b, but the number of microlenses configuring the second microlens group 41 is not limited thereto. As described above, the second microlens group 41 may be configured by one microlens, or may be configured by two or more microlenses. The second microlens group 41 may be configured by a diffractive lens or a metalens, for example.

As illustrated in FIG. 5, the divergent light L2 becomes the parallel light L3 in the first detection mechanism 30. As illustrated in FIG. 7, the parallel light L3 is refracted by the second microlens group 41 of the second detection mechanism 40. Refracted light L4 having passed through the second microlens group 41 gathers at a focal position F of the second microlens group 41. Note that the “focal position” in the present specification means a composite focal position in a case where the second microlens group 41 is configured by a plurality of microlenses.

A focal length of the second microlens group 41 is, for example, 0.0003 mm or more and 3 mm or less. Note that the “focal length” in the present specification means a composite focal length in a case where the second microlens group 41 is configured by the plurality of microlenses.

### 2-3-2. Light Shielding Film

As illustrated in FIG. 7, the second detection mechanism 40 may include a light shielding film 42 having an opening 43. In the second detection mechanism 40, the opening 43 is arranged corresponding to the focal position F of the second microlens group 41. By providing the light shielding film 42 having the opening 43, unnecessary light and stray light, which are noise, can be reduced, and color mixing can be suppressed by passing only light directly above the opening 43. Therefore, the SN ratio in the fluorescence detection device 1 can be further improved.

A shape of the opening 43 of the light shielding film 42 in plan view may be, for example, a circular shape, a square shape, or a polygonal shape, but is not limited thereto.

The diameter of the opening 43 of the light shielding film 42 is, for example, 0.0003 mm or more and 0.01 mm or less. Note that in the present specification, the “diameter of the opening” is a diameter in a case where the shape of the opening 43 in plan view is a circular shape, and is a diameter of a minimum inclusion circle in a case where the shape is other than the circular shape. For example, in a case where the planar shape of the opening 43 is a polygonal shape, the diameter of the opening 43 is the diameter of the smallest circle including the polygon.

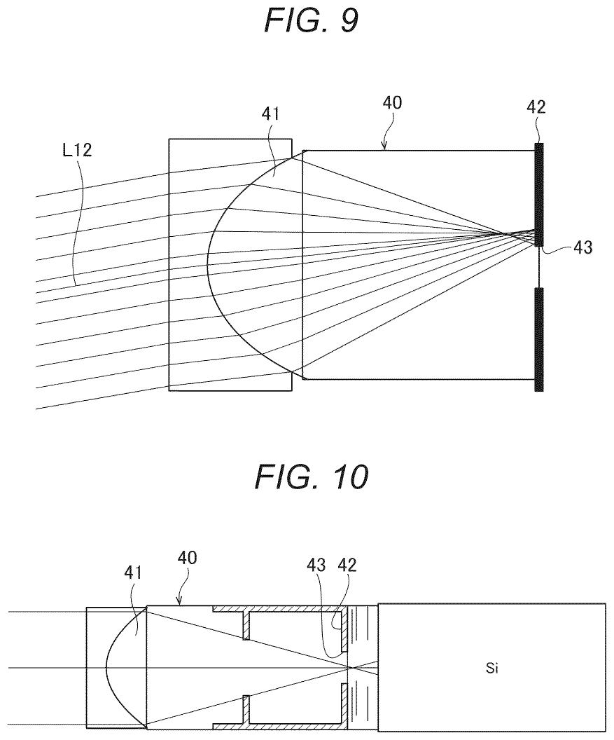

With reference to FIGS. 8 and 9, the function of the light shielding film 42 will be described. FIGS. 8 and 9 are schematic diagrams illustrating light incident on the second detection mechanism 40. Note that, in the second detection mechanism 40 illustrated in FIGS. 8 and 9, the left side in the drawing is the first detection mechanism side (the upper side in FIG. 7), and the right side in the drawing is the solid-state imaging element side (the lower side in FIG. 7).

FIG. 8 illustrates an incident light L11 having an angle of view of 0°. The focal position F of the second microlens group 41 is an imaging position of the incident light L11. By providing the opening 43 of the light shielding film 42 at a position corresponding to the focal position F (see FIG. 7), only on-axis light rays can pass through the opening. Thus, the fluorescence reaching the light receiving surface of the solid-state imaging element from the micro-well 21 has an optical axis perpendicular to the light receiving surface. More specifically, the fluorescence that has passed through the first microlens group 31 (first detection mechanism 30), the second microlens group 41 (second detection mechanism 40), and the opening 43 of the light shielding film 42 corresponding to one micro-well 21 has an optical axis perpendicular to the light receiving surface of the solid-state imaging element.

FIG. 9 illustrates an incident light L12 of an angle of view of 10°. An off-axis ray of the incident light L12 is deviated from the focal position F of the second microlens group 41 in terms of calculation. In this case, when the diameter of the opening 43 of the light shielding film 42 has a size capable of blocking the off-axis ray described above, the off-axis ray can be blocked. For example, in a case where the off-axis ray of the incident light L12 is deviated from the focal position F by 0.93 μm in terms of calculation, when the opening 43 having a diameter of 1 μm is arranged corresponding to the focal position F, the off-axis ray can be blocked.

The light shielding film 42 having the opening 43 is, for example, in a production process of a solid-state imaging element. FIG. 10 is a schematic diagram illustrating a solid-state imaging element having silicon (Si) substrate and a second detection mechanism 40 including a light shielding film 43. The light shielding film 43 illustrated in FIG. 10 is manufactured in a production process of the solid-state imaging element, and specifically, can be manufactured in a step after a manufacturing step of the silicon substrate. Therefore, the solid-state imaging element and the second detection mechanism 40 including the light shielding film 43 can be manufactured through a series of production step.

### 2-4. Solid-state Imaging Element

In the fluorescence detection device 1, the solid-state imaging element is provided, below the first detection mechanism 30, corresponding to each of the first detection mechanisms 30. In a case where the fluorescence detection device 1 includes the second detection mechanism 40, the solid-state imaging element is provided, below the second detection mechanism 40, corresponding to each of the second detection mechanisms 40.

The solid-state imaging element is provided in the solid-state imaging device 100 illustrated in FIG. 2. The solid-state imaging device 100 may be, for example, a back-illuminated complementary metal oxide semiconductor (CMOS) type solid-state imaging device, but is not limited thereto.

### 2-5. Light Source

The fluorescence detection device 1 may further include a light source that applies the excitation light. In a case where the fluorescence detection device 1 includes the light source, the excitation light applied to the test object accommodated in the micro-well 21 is emitted from the light source. In this case, the light source is provided, for example, above the micro-well array layer 20.

The light source is not an essential component of the fluorescence detection device 1. The light source may be provided, for example, outside the fluorescence detection device 1.

### 2-6. Other Components

Another component of the fluorescence detection device 1 will be described with reference to FIG. 2 again. The fluorescence detection device 1 may further include a ceramic package 210. In this case, the fluorescence detection device plate 10 and the solid-state imaging device 100 are arranged inside the ceramic package 210. The solid-state imaging device 100 is electrically connected to the outside by, for example, wire bonding via a wire 220.

### 2-7. Test Object

The test object S accommodated in the micro-well 21 of the fluorescence detection device 1 is, for example, cells, cell masses, microorganisms, biomolecules, and the like. The cells described above may include animal cells and plant cells. The cell masses described above may include spheroids, organoids, and the like. The microorganisms described above may include bacteria such as Escherichia coli, viruses such as coronavirus, fungi such as yeast, and the like. The biomolecules described above may include biological polymers such as nucleic acids, proteins, and complexes thereof.

A chemical or biological label such as fluorescent dye or fluorescent protein, for example, may be attached to the test object S, as necessary. The label that should be attached can be appropriately selected by one skilled in the art.

### 3. Each Embodiment of Fluorescence Detection Device

There are a plurality of embodiments as the fluorescence detection device according to the present technology.

Hereinafter, each embodiment will be described.

### 3-1. First Embodiment

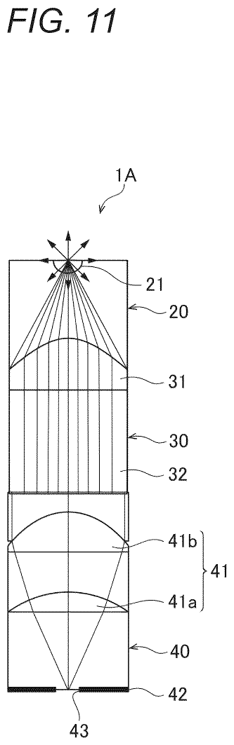

FIG. 11 is a schematic diagram illustrating a cross section of a portion of a fluorescence detection device 1A according to the first embodiment. As illustrated in FIG. 11, the fluorescence detection device 1A includes, in order from the top, the micro-well array layer 20 having the micro-wells 21 on an upper surface, the first detection mechanism 30, and the second detection mechanism 40. Furthermore, the fluorescence detection device 1A includes a solid-state imaging element below the second detection mechanism 40 (not illustrated). That is, in the fluorescence detection device 1A, corresponding to one micro-well 21, a constituent unit including a combination of one first detection mechanism 30, one second detection mechanism 40, and one solid-state imaging element which are arranged in the vertical direction.

The first detection mechanism 30 includes, in order from the top (from the micro-well 21 side), the first microlens group 31 having positive power, and the optical filter 32 that blocks the excitation light and transmits the fluorescence. The second detection mechanism 40 includes, in order from the top (from the first detection mechanism 30 side), the second microlens group 41 having positive power and the light shielding film 42 having the opening 43. The opening 43 is arranged corresponding to the focal position of the second microlens group 41.

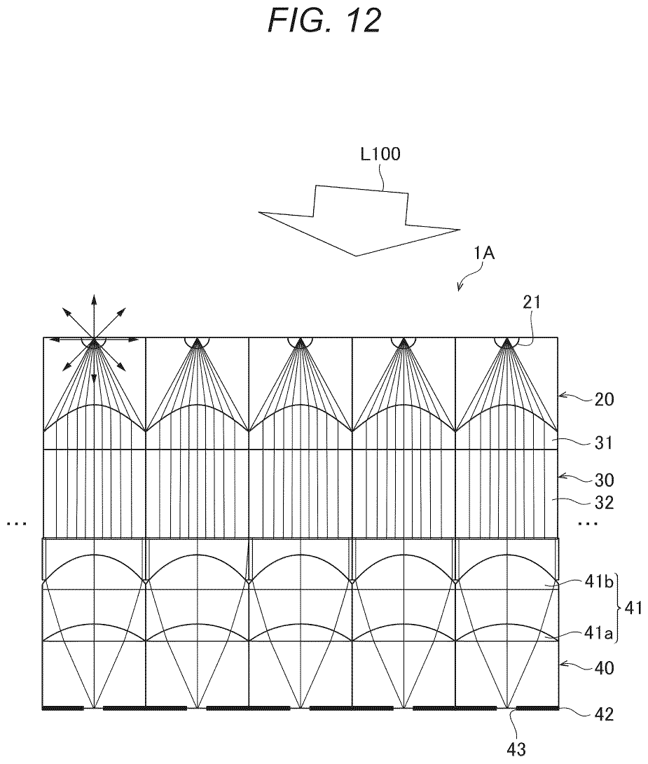

FIG. 12 is a schematic diagram illustrating a cross section of a portion of the fluorescence detection device 1A according to the first embodiment. FIG. 12 illustrates a cross section of a range wider in the horizontal direction than the cross section illustrated in FIG. 11. As illustrated in FIG. 12, in the fluorescence detection device 1A, a plurality of constituent units in FIG. 11 is arranged in parallel in the horizontal direction corresponding to the respective micro-wells 21.

Although not illustrated in FIG. 12, the solid-state imaging element is provided, below the second detection mechanism 40, corresponding to each second detection mechanism 40.

According to the fluorescence detection device 1A, the light use efficiency can be improved by the first microlens group 31 and the second microlens group 41. Furthermore, the SN ratio may be improved by the optical filter 32 and the light shielding film 42.

The excitation light L100 is applied from the top of the fluorescence detection device 1A. The excitation light L100 is preferably applied from directly above or obliquely above the fluorescence detection device 1A, and more preferably applied from obliquely above. Specifically, the excitation light L100 is preferably applied vertically or obliquely to the upper surface of the micro-well array layer 20, and more preferably obliquely applied to the upper surface of the micro-well array layer 20. In a case where the excitation light L100 is vertically applied, the incidence angle of the excitation light L100 is 0°. In a case where the excitation light L100 is obliquely applied, the incidence angle of the excitation light L100 is, for example, 10° or more and 60° or less, preferably 20° or more and 40° or less, more preferably 25° or more and 35° or less, and further more preferably 30° or more and 35° or less. Note that the incidence angle of the excitation light is an angle made between a direction orthogonal to a plane direction of the micro-well array layer 20 and an optical axis of the excitation light.

By obliquely applying the excitation light L100, the excitation light L100 reaching the light receiving surface of the solid-state imaging element can be further reduced.

Particularly, by obliquely applying at the incidence angle within the numerical value range described above, the excitation light L100 reaching the light receiving surface of the solid-state imaging element can be further efficiently reduced. Note that a result of verifying the excitation light reducing effect in a case where the excitation light L100 is obliquely applied will be described in the following “3-2. Second Embodiment”.

As described above, the SN ratio in the fluorescence detection device 1A can be further improved by adjusting the incidence angle of the excitation light L100 to reduce the excitation light, which is noise.

3-1-1. Modification of first Embodiment

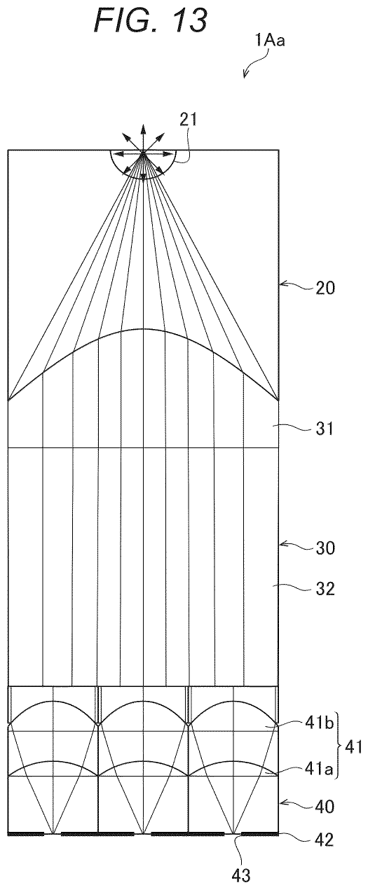

FIG. 13 is a schematic diagram illustrating a cross section of a portion of a fluorescence detection device 1Aa according to a modification of the first embodiment. The fluorescence detection device 1Aa according to the modification is different from the fluorescence detection device 1A according to the first embodiment in that a plurality of the second detection mechanisms 40 is included for one micro-well 21, and is the same as the fluorescence detection device 1A in other points. FIG. 13 illustrates three second detection mechanisms 40 for one micro-well 21, but the number of the second detection mechanisms 40 is not limited thereto, and only need be two or more.

The fluorescence detection device 1Aa includes, in order from the top, the micro-well array layer 20 having the micro-wells 21 on the upper surface, the first detection mechanism 30, and the second detection mechanism 40. Furthermore, the fluorescence detection device 1Aa include the solid-state imaging element, below the second detection mechanism 40, corresponding to each of the second detection mechanisms 40 (not illustrated). In the fluorescence detection device 1Aa, a constituent unit is formed, in which a plurality of combinations of the one second detection mechanism 40 and the one solid-state imaging element, which are arranged in a vertical direction, is arranged in parallel in a horizontal direction corresponding to one micro-well 21. In this manner, in the fluorescence detection device 1Aa, the plurality of second detection mechanisms 40 and the plurality of solid-state imaging elements are provided for one micro-well 21.

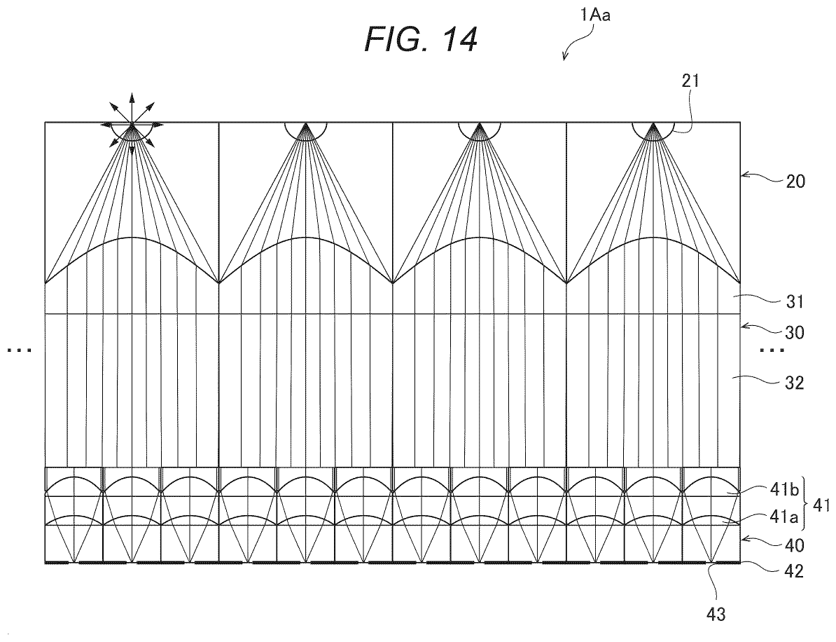

FIG. 14 is a schematic diagram illustrating a cross section of a portion of the fluorescence detection device 1Aa according to a modification of the first embodiment. FIG. 14 illustrates a cross section of a range wider in the horizontal direction than the cross section illustrated in FIG. 13. As illustrated in FIG. 14, in the fluorescence detection device 1Aa, a plurality of the constituent units in FIG. 13 is arranged in parallel in the horizontal direction corresponding to the respective micro-wells 21. Although not illustrated in FIG. 14, the solid-state imaging element is provided, below the second detection mechanism 40, corresponding to each second detection mechanism 40.

The fluorescence detection device 1Aa includes a plurality of the solid-state imaging elements for one micro-well 21.

Therefore, according to the fluorescence detection device 1Aa, fluorescence emitted from the test object in the micro-well 21 can be detected with higher sensitivity.

### 3-2. Second Embodiment

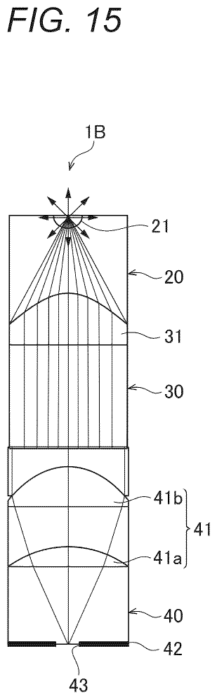

FIG. 15 is a schematic diagram illustrating a cross section of a portion of a fluorescence detection device 1B according to the second embodiment. The fluorescence detection device 1B according to the second embodiment is different from the fluorescence detection device 1A according to the first embodiment in that the first detection mechanism 30 does not include an optical filter, and is the same as the fluorescence detection device 1A in other points.

The fluorescence detection device 1B includes, in order from the top, the micro-well array layer 20 having the micro-wells 21 on the upper surface, the first detection mechanism 30, and the second detection mechanism 40. Furthermore, the fluorescence detection device 1B includes the solid-state imaging element below the second detection mechanism 40 (not illustrated). That is, in the fluorescence detection device 1B, corresponding to one micro-well 21, a constituent unit including a combination of one first detection mechanism 30, one second detection mechanism 40, and one solid-state imaging element which are arranged in the vertical direction.

In the fluorescence detection device 1B, the first detection mechanism 30 includes the first microlens group 31 having positive power and does not include the optical filter.

The second detection mechanism 40 includes, in order from the top (from the first detection mechanism 30 side), the second microlens group 41 having positive power and the light shielding film 42 having an opening 43. The opening 43 is arranged corresponding to the focal position of the second microlens group 41.

Unlike the fluorescence detection device 1A according to the first embodiment, the fluorescence detection device 1B according to the second embodiment does not include the optical filter. Therefore, the fluorescence detection device 1B is advantageous as compared with the fluorescence detection device 1A from the viewpoint of manufacturing cost, but there is a case where the SN ratio may be inferior because the amount of excitation light reaching the light receiving surface of the solid-state imaging element may increase.

In order to reduce the excitation light reaching the light receiving surface of the solid-state imaging element and suppress a decrease in the SN ratio, it is preferable that the excitation light is obliquely applied to the upper surface of the micro-well array layer 20 as described above in “3-1. First Embodiment”. In a case where the excitation light is obliquely applied, a preferable numerical value range of the incidence angle of the excitation light is as described above in 3-1.

Here, a result of simulation for verifying the relationship between the incidence angle of the excitation light and the amount of the excitation light reaching the light receiving surface of the solid-state imaging element will be described.

This simulation verifies how the amount of excitation light reaching the light receiving surface of the solid-state imaging element changes in a case where the incidence angle of the excitation light is varied in the fluorescence detection device 1B not including the optical filter.

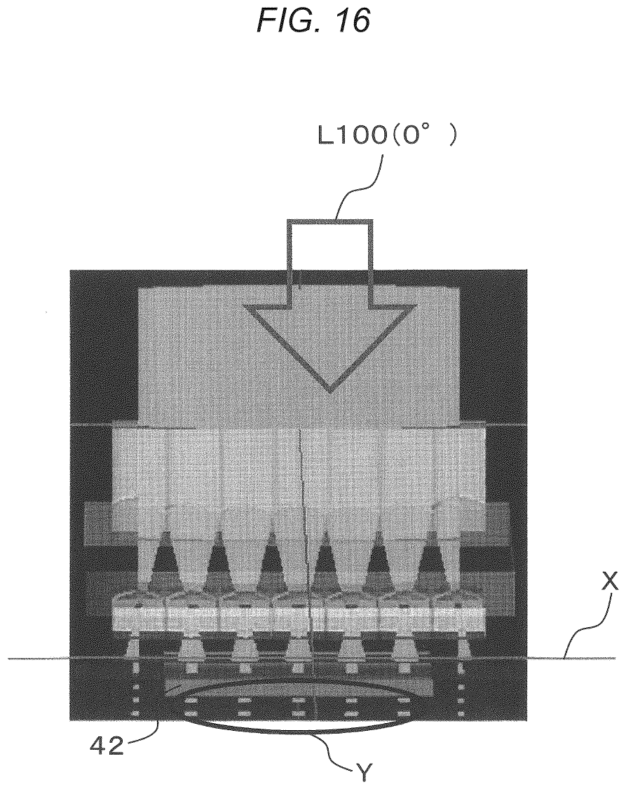

FIGS. 16 to 18 are diagrams illustrating a result of simulation in a case where the incidence angle of the excitation light L100 is 0°, 30°, or 33°, respectively. In FIG. 16, a solid line X indicates a position where the opening of the light shielding film 42 is provided. An ellipse Y indicates excitation light having passed the opening of the light shielding film 42. As illustrated in FIG. 16, the excitation light L100 having an incidence angle of 0° is applied, then a part of the excitation light 00 passes through the opening of the light shielding film 42 and reaches the light receiving surface of the solid-state imaging element.

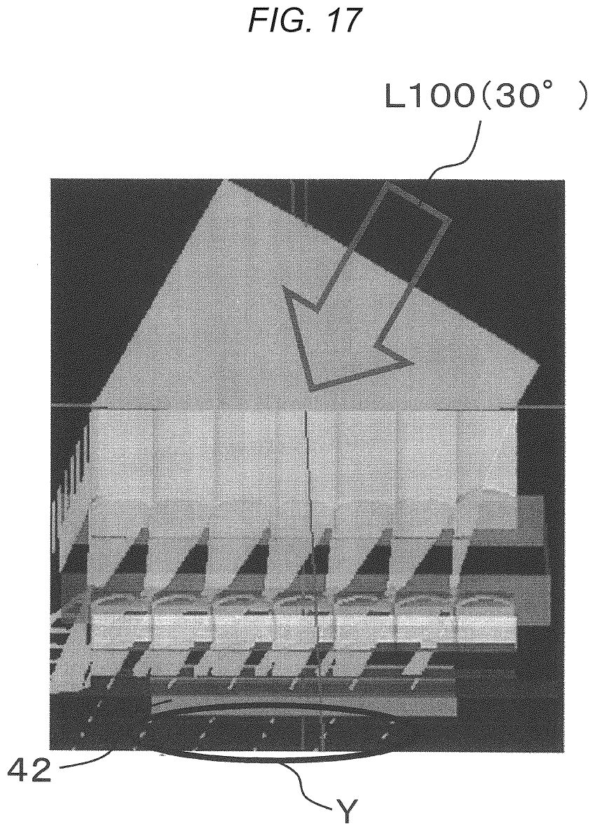

As illustrated in FIG. 17, the excitation light L100 having an incidence angle of 30° is applied, then a part of the excitation light L100 passes through the opening of the light shielding film 42 and reaches the light receiving surface of the solid-state imaging element. However, the amount of the excitation light L100 passing through the opening in a case where the incidence angle is 30° is smaller than in a case where the incidence angle is 0°. This is because the amount of the excitation light L100 blocked by the light shielding film 42 increases by obliquely applying the excitation light L100.

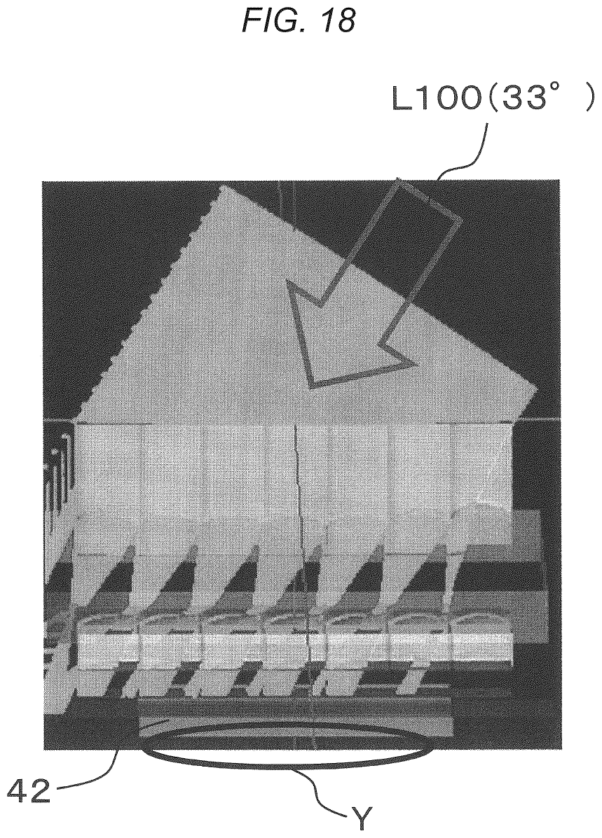

As illustrated in FIG. 18, the excitation light L100 having an incidence angle of 33° is applied, then the excitation light L100 is blocked by the light shielding film 42, and does not reach the light receiving surface of the solid-state imaging element.

From the results of the simulation illustrated in FIGS. 16 to 18, it can be seen that the light shielding film 42 can reduce or block the excitation light L100 by adjusting the incidence angle of the excitation light L100 in the fluorescence detection device 1B not including the optical filter. From this result, it can be seen that even in a case where the fluorescence detection device does not include the optical filter, the SN ratio can be suppressed by adjusting the incidence angle of the excitation light L100 to reduce the amount of the excitation light L100 reaching the light receiving surface of the solid-state imaging element.

### 3-3. Third Embodiment

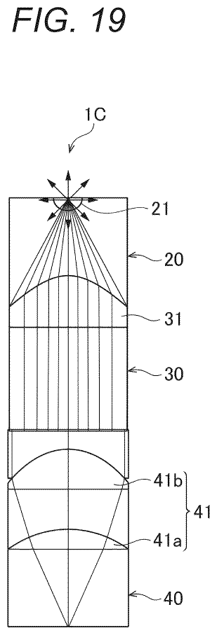

FIG. 19 is a schematic diagram illustrating a cross section of a portion of a fluorescence detection device 1C according to the third embodiment. The fluorescence detection device 1C according to the third embodiment is different from the fluorescence detection device 1B according to the second embodiment in that the second detection mechanism 40 does not include a light shielding film having an opening, and is the same as the fluorescence detection device 1B in other points.

The fluorescence detection device 1C includes, in order from the top, the micro-well array layer 20 having the micro-well 21 on the upper surface, the first detection mechanism 30, and the second detection mechanism 40. Furthermore, the fluorescence detection device 1C includes a solid-state imaging element below the second detection mechanism 40 (not illustrated). That is, in the fluorescence detection device 1C, corresponding to one micro-well 21, a constituent unit including a combination of one first detection mechanism 30, one second detection mechanism 40, and one solid-state imaging element which are arranged in the vertical direction.

The first detection mechanism 30 of the fluorescence detection device 1C includes the first microlens group 31 having positive power and does not include the optical filter. The second detection mechanism 40 includes a second microlens group 41 having positive power, and does not include the light shielding film having the opening.

The fluorescence detection device 1C according to the third embodiment is advantageous from the viewpoint of manufacturing cost as compared with the fluorescence detection device 1A according to the first embodiment and the fluorescence detection device 1B according to the second embodiment, but there may be a case where the SN ratio is inferior. This is because the fluorescence detection device 1C does not include an optical filter and a light shielding film for blocking or reducing excitation light, and the amount of excitation light reaching the light receiving surface of the solid-state imaging element can increase. However, since the fluorescence detection device 1C increases the light use efficiency by the first microlens group 31 and the second microlens group 41, the fluorescence emitted from the test object can be detected. For example, the fluorescence detection device 1C may be adopted in a case where the manufacturing cost reduction is prioritized over the SN ratio improvement.

### 3-3-1. Modification of Third Embodiment

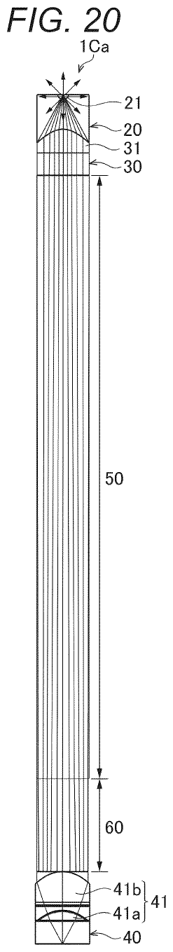

FIG. 20 is a schematic diagram illustrating a cross section of a portion of a fluorescence detection device 1Ca according to a modification of the third embodiment. The fluorescence detection device 1Ca according to the modification is different from the fluorescence detection device 1C according to the third embodiment in that the fluorescence detection device 1Ca includes a substrate 50 and an air layer 60, and is the same as the fluorescence detection device 1C in other points.

The fluorescence detection device 1Ca includes, in order from the top, the micro-well array layer 20 having the micro-well 21 on the upper surface, the first detection mechanism 30, the substrate 50, the air layer 60, and the second detection mechanism 40. Furthermore, the fluorescence detection device 1Ca includes a solid-state imaging element below the second detection mechanism 40 (not illustrated). That is, in the fluorescence detection device 1Ca, corresponding to one micro-well 21, a constituent unit is formed including a combination of one first detection mechanism 30, the substrate 50, the air layer 60, one second detection mechanism 40, and one solid-state imaging element which are arranged in the vertical direction.

The substrate 50 is a plate-like member for disposing the micro-well array layer 20 and the first detection mechanism 30. The substrate 50 may includes, for example, glass. The substrate 50 is provided below the first detection mechanism 30, and more specifically, is provided between the first detection mechanism 30 and the air layer 60.

The air layer 60 is a portion where no constituent member is arranged. The air layer 60 is provided below the substrate 50, and more specifically, is provided between the substrate 50 and the second detection mechanism 40. The air layer 60 is formed when the substrate 50 and the second detection mechanism 40 are separately arranged.

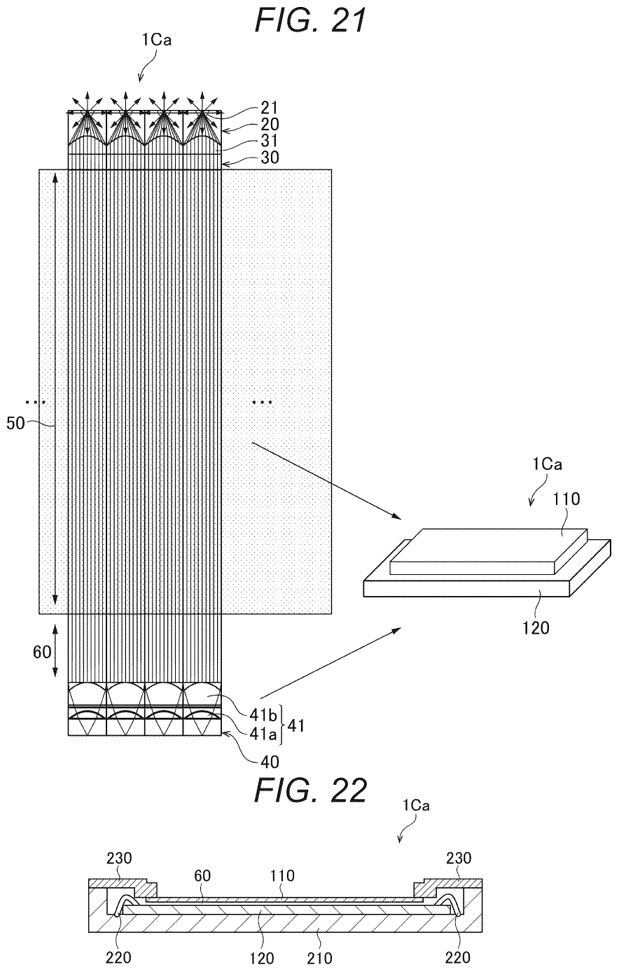

FIG. 21 is a schematic diagram illustrating an example of the fluorescence detection device 1Ca according to the modification of the third embodiment. The left side of FIG. 21 illustrates a cross section of a portion of the fluorescence detection device 1Ca. The left side of FIG. 21 illustrates a cross section of a range wider in the horizontal direction than the cross section illustrated in FIG. 20. As illustrated in the left side of FIG. 21, in the fluorescence detection device 1Ca, a plurality of the constituent units in FIG. 20 is arranged in parallel in the horizontal direction corresponding to the respective micro-wells 21. Although not illustrated in FIG. 21, the solid-state imaging element is provided, below the second detection mechanism 40, corresponding to each second detection mechanism 40.

The right side of FIG. 21 illustrates an example of a configuration of the fluorescence detection device 1Ca. As illustrated on the right side of FIG. 21, the fluorescence detection device 1Ca may include, in order from the top, a micro-well array substrate part 110 and a sensor part 120. The micro-well array substrate part 110 includes, in order from the top, the micro-well array layer 20, the first detection mechanism 30, and the substrate 50. The sensor part 120 includes, in order from the top, the second detection mechanism 40 and the solid-state imaging element. The air layer 60 is provided between the micro-well array substrate part 110 and the sensor part 120. In this manner, the fluorescence detection device 1Ca may have a configuration including, in order from the top, the micro-well array substrate part 110, the air layer 60, and the sensor part 120.

FIG. 22 is a schematic diagram illustrating a cross section of an example of a fluorescence detection device 1Ca according to a modification of the third embodiment. The fluorescence detection device 1Ca illustrated in FIGS. 20 and 21 has an overall configuration illustrated in FIG. 22, for example.

Specifically, the fluorescence detection device 1Ca includes the ceramic package 210. The sensor part 120 is arranged in the inner side of the ceramic package 210. The sensor part 120 is electrically connected to the outside by, for example, wire bonding via the wire 220.

The fluorescence detection device 1Ca further includes a holding part 230 that holds the micro-well array substrate part 110 separately from the sensor part 120. That is, the micro-well array substrate part 110 is held at a position separated upward from the sensor part 120 by the holding part 230.

Therefore, the air layer 60 is formed between the micro-well array substrate part 110 and the sensor part 120.

By providing the air layer 60 between the micro-well array substrate part 110 and the sensor part 120, the micro-well array substrate part 110 can have a structure separable from the sensor part 120. Therefore, after completion of a series of fluorescence detection work using the micro-well array substrate part 110, the used micro-well array substrate part 110 can be replaced with a new micro-well array substrate part 110.

Therefore, a constituent member other than the micro-well array substrate part 110 can be repeatedly used.

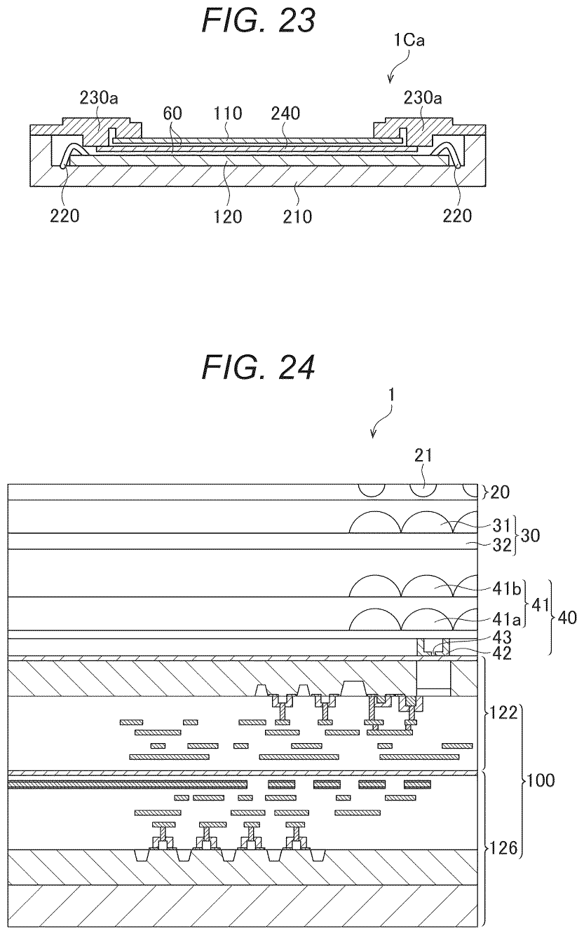

FIG. 23 is a schematic diagram illustrating a cross section of an example of a fluorescence detection device 1Ca according to a modification of the third embodiment. Unlike FIG. 22, the fluorescence detection device 1Ca illustrated in FIG. 23 includes a protective plate part 240.

The protective plate part 240 is a plate-like member that protects the sensor part 120. The protective plate part 240 may includes, for example, glass. The protective plate part 240 is provided between the micro-well array substrate part 110 and the sensor part 120. The micro-well array substrate part 110 and the protective plate part 240 are separated, and the protective plate part 240 and the sensor part 120 are separated.

Therefore, there is the air layer 60 (first air layer) between the micro-well array substrate part 110 and the protective plate part 240, and there is also the air layer 60 (second air layer) between the protective plate part 240 and the sensor part 120.

That is, the protective plate part 240 in FIG. 23 is provided in a position corresponding to the air layer 60 illustrated in FIG. 22.

The fluorescence detection device 1Ca illustrated in FIG. 23 includes a holding part 230a. The holding part 230a holds the micro-well array substrate part 110 and the protective plate part 240. More specifically, the holding part 230a holds the micro-well array substrate part 110 separately from the protective plate part 240, and holds the protective plate part 240 separately from the sensor part 120. In this manner, the micro-well array substrate part 110 is held at a position separated upward from the protective plate part 240.

Furthermore, the protective plate part 240 is held at a position separated upward from the sensor part 120.

By providing the protective plate part 240 as illustrated in FIG. 23, it is possible to prevent the sensor part 120 from being exposed when the micro-well array substrate part 110 is replaced. Therefore, the sensor part 120 can be protected from contamination.

The modifications and the embodiments of the present technology have been described above. However, the configuration of the fluorescence detection device of the present technology is not limited to the configurations of the embodiments and the modifications described above. The components of each of the embodiments and modifications may be appropriately combined as far as technological inconsistence does not occur.

As an example, the configuration including the air layer described in the above “3-3-1. Modification of third embodiment”, that is, the configuration in which the micro-well array substrate part is replaceable may be adopted in the fluorescence detection device of the first embodiment or the second embodiment.

In this case, the fluorescence detection device of the first embodiment or the second embodiment may include, in order from the top, the micro-well array substrate part, the air layer, and the sensor part. The micro-well array substrate part includes, in order from the top, the micro-well array layer, and the first detection mechanism. The sensor part includes, in order from the top, a second detection mechanism and a solid-state imaging element. That is, in this case, the air layer is provided between the first detection mechanism and the second detection mechanism. By adopting such a configuration, the micro-well array substrate part (the micro-well array layer and the first detection mechanism) can be replaced every time it is used, and the components (the second detection mechanism and the solid-state imaging element) other than the micro-well array substrate part can be repeatedly used.

### 4. Method for Manufacturing Fluorescence Detection Device

Next, an example of a method for manufacturing the fluorescence detection device 1 will be described. Here, a case where the fluorescence detection device 1 includes a back-illuminated CMOS solid-state imaging device 100 will be described as an example.

FIG. 24 is a schematic diagram illustrating a cross section of an example of the fluorescence detection device 1. The fluorescence detection device 1 includes, in order from the top, the micro-well array layer 20, the first detection mechanism 30, the second detection mechanism 40, and the solid-state imaging device 100. The solid-state imaging device 100 includes, in order from the top, a first semiconductor chip part 122 and a second semiconductor chip part 126. The first semiconductor chip part 122 includes a pixel region and a control region. The second semiconductor chip part 126 includes a logic circuit.

The first semiconductor chip part 122 and the second semiconductor chip part 126 are stacked vertically in an electrically connected state.

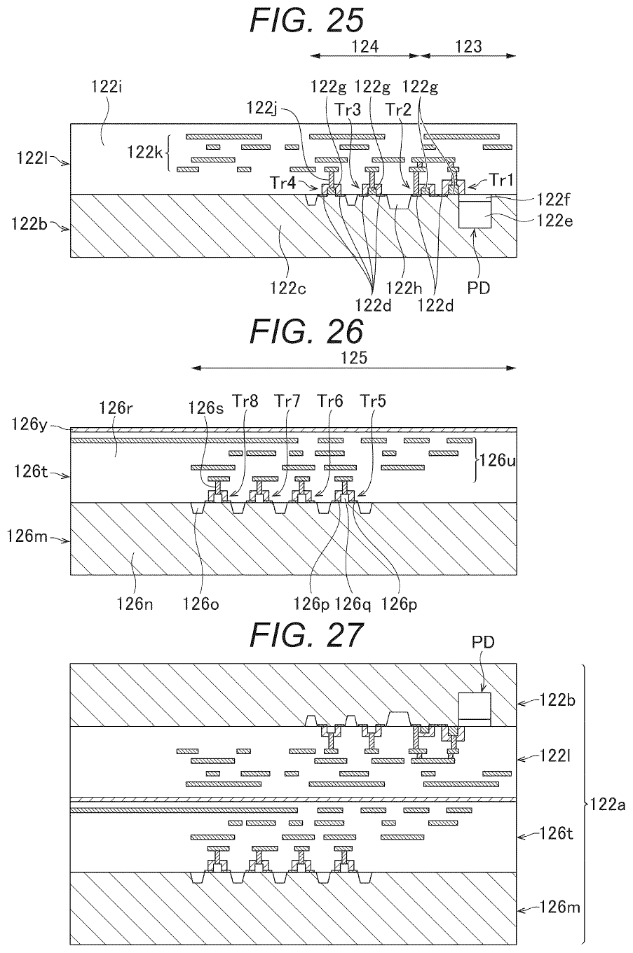

With reference to FIGS. 25 to 36, the method for manufacturing the fluorescence detection device 1 is described.

First, as illustrated in FIG. 25, an image sensor in a semi-manufactured state, that is, a pixel region 123 and a control region 124, is formed in a region serving as each chip part of the first semiconductor substrate 122b.

Specifically, a photodiode PD to be a photoelectric conversion part of each pixel is formed in a region to be each chip part of the first semiconductor substrate 122b including a silicon substrate. Furthermore, a source/drain region 122d of each pixel transistor is formed in a semiconductor well region 122c. The semiconductor well region 122c is formed by introducing an impurity of a first conductivity type (for example, a p-type). The source/drain region 122d is formed by introducing an impurity of a second conductivity type (for example, an n-type).

The photodiode PD and the source/drain region 122d of each pixel transistor are formed by ion implantation from a front surface of a substrate. The photodiode PD is formed to have an n-type semiconductor region 122e, and a p-type semiconductor region 122f on a substrate surface side.

A gate electrode 122g is formed on the substrate surface configuring a pixel via a gate insulating film. Pixel transistors Tr1 and Tr2 are formed with the source/drain region 122d, which is one of a pair with the gate electrode 122g. FIG. 25 illustrates a plurality of pixel transistors, as represented by the two pixel transistors Tr1 and Tr2. The pixel transistor Tr1 adjacent to the photodiode PD corresponds to a transfer transistor, and the source/drain region 122d thereof corresponds to a floating diffusion.

Each unit pixel is separated in an element separation region 122h.

Meanwhile, on the control region 124 side, a MOS transistor that configures a control circuit in the first semiconductor substrate 122b is formed. FIG. 25 illustrates MOS transistors that configures the control region 124, as represented by MOS transistors Tr3 and Tr4. Each of the MOS transistors Tr3 and Tr4 is formed by the gate electrode 122g formed via an n-type source/drain region 122d and the gate insulating film.

Next, a first interlayer insulating film 122i is formed on the first semiconductor substrate 122b. Thereafter, a contact hole is formed in the interlayer insulating film 122i, and a connection conductor 122j connected to a desired transistor is formed. When the connection conductors 122j having different heights are formed, on an entire surface including an upper surface of a transistor, a first thin insulation film includes a silicon-oxide film, for example, and a second thin insulation film serving as an etching stopper includes a silicon-nitride film, for example, and laminated. The first interlayer insulating film 1221 is formed on the second thin insulation film.

Thereafter, contact holes having different depths are selectively formed in the first interlayer insulating film 122i up to the second thin insulation film serving as an etching stopper. Next, the first thin insulation film and the second thin insulation film having the same film thickness in each part are selectively etched so as to be continuous with each contact hole, to form a contact hole. Then, the connection conductor 122j is embedded in each contact hole.

Next, a plurality of layers, four layers in this example, of copper wiring lines 122k is formed to be connected to each connection conductor 122j via the interlayer insulating film 122i, to form a first multi-layer wiring layer 1221. Usually, each copper wiring line 122k is covered with a barrier metal layer, which is not illustrated, in order to prevent Cu diffusion. The first multi-layer wiring layer 1221 is formed by alternately forming the interlayer insulating film 122i and the copper wiring line 122k formed via the barrier metal layer. In this example, the first multi-layer wiring layer 1221 is formed with the copper wiring line 122k, as an example, but the first multi-layer wiring layer 1221 may be a metal wiring line including another metal material.

In the processes so far, there is formed the first semiconductor substrate 122b having the first multi-layer wiring layer 1221 on an upper part thereof, and having the semi-manufactured pixel region 123 and control region 124.

Meanwhile, as illustrated in FIG. 26, a logic circuit 125 is formed including a semi-manufactured signal processing circuit for performing signal processing in a region serving as each chip unit of a second semiconductor substrate 126m including silicon, for example. That is, a plurality of MOS transistors that constitutes the logic circuit 125 is formed on a p-type semiconductor well region 126n on a front-surface side of the second semiconductor substrate 126m, so as to be separated in an element separation region 1260. Here, the plurality of MOS transistors is represented by MOS transistors Tr5, Tr6, Tr7, and Tr8. Each of the MOS transistors Tr5, Tr6, Tr7, and Tr8 is formed to have a pair of n-type source/drain regions 126p and a gate electrode 126q formed via the gate insulating film. The logic circuit 125 can be configured by the MOS transistor.

Next, a first interlayer insulating film 126r is formed on the surface of the second semiconductor substrate 126m.

Thereafter, a contact hole is formed in the interlayer insulating film 126r, and a connection conductor 126s connected to a desired transistor is formed. When the connection conductors 126s having different heights are formed, in a similar manner as above, on an entire surface including the upper surface of the transistor, the first thin insulation film (for example, a silicon-oxide film) and the second thin insulation film (for example, silicon-nitride film) serving as the etching stopper are laminated. The first interlayer insulating film 126r is formed on the second thin insulation film.

Then, contact holes having different depths are selectively formed in the first interlayer insulating film 126r up to the second thin insulation film serving as an etching stopper.

Next, the first thin insulation film and the second thin insulation film having the same film thickness in each part are selectively etched so as to be continuous with each contact hole, to form a contact hole. Then, the connection conductor 126s is embedded in each contact hole.

Thereafter, formation of the interlayer insulating film 126r and formation of the plurality of layers of metal wiring lines are repeated to form a second multi-layer wiring layer 126t. In this example, four layers of copper wiring lines 126u are formed in a similar manner as the formation step of the first multi-layer wiring layer 1221 formed on the first semiconductor substrate 122b, and the second multi-layer wiring layer 126t is formed.

Then, a warpage correction film 126y for reducing warpage when the first semiconductor substrate 122b and the second semiconductor substrate 126m are bonded together is formed on an upper part of the second multi-layer wiring layer 126t.

In the processes so far, there is formed the second semiconductor substrate 126m having the second multi-layer wiring layer 126t on an upper part thereof, and having a semi-manufactured logic circuit.

Next, as illustrated in FIG. 27, the first semiconductor substrate 122b and the second semiconductor substrate 126m are bonded together so that the first multi-layer wiring layer 1221 and the second multi-layer wiring layer 126t face each other. The bonding is performed with, for example, an adhesive. Alternatively, the bonding may be performed with plasma bonding. Then, the first semiconductor substrate 122b having a multi-layer wiring layer on an upper part thereof and the second semiconductor substrate 126m are laminated and bonded to each other, thereby forming a laminated body 122a including two dissimilar substrates.

Next, the first semiconductor substrate 122b is ground and polished from a back surface side thereof, and the first semiconductor substrate 122b is thinned. This thinning is performed such that the photodiode PD faces. After the thinning, a p-type semiconductor layer (not illustrated) for suppressing dark current is formed on the back surface of the photodiode PD. A thickness of the first semiconductor substrate 122b is, for example, about 600 μm, but is thinned to, for example, about 3 μm to 5 μm. The back surface of the first semiconductor substrate 122b serves as a light incident surface when configured as a back-illuminated solid-state imaging device.

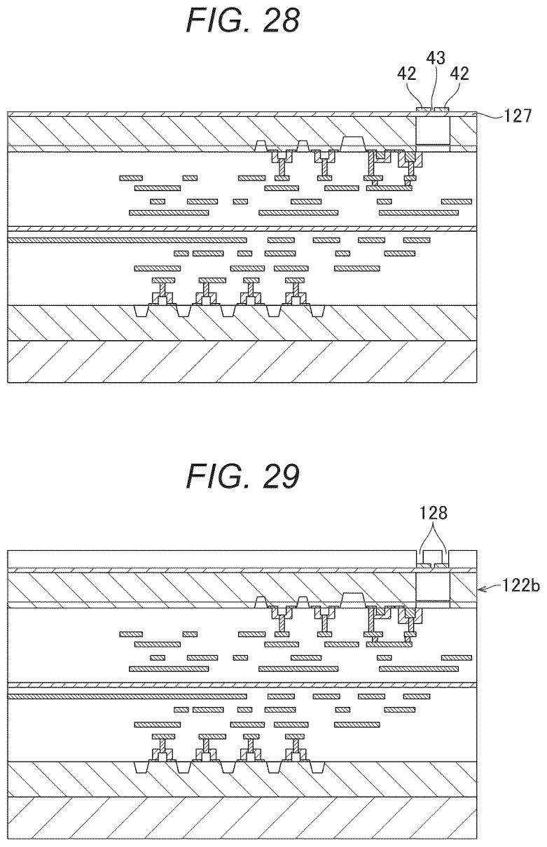

Next, as illustrated in FIG. 28, an antireflection coating 127 is applied to the silicon surface. Thereafter, tungsten as a material of the light shielding film 42 is formed with a thickness of, for example, 350 nm on the photodiode PD, and the surface is polished with a chemical mechanical polishing (CMP) method to form the opening 43.

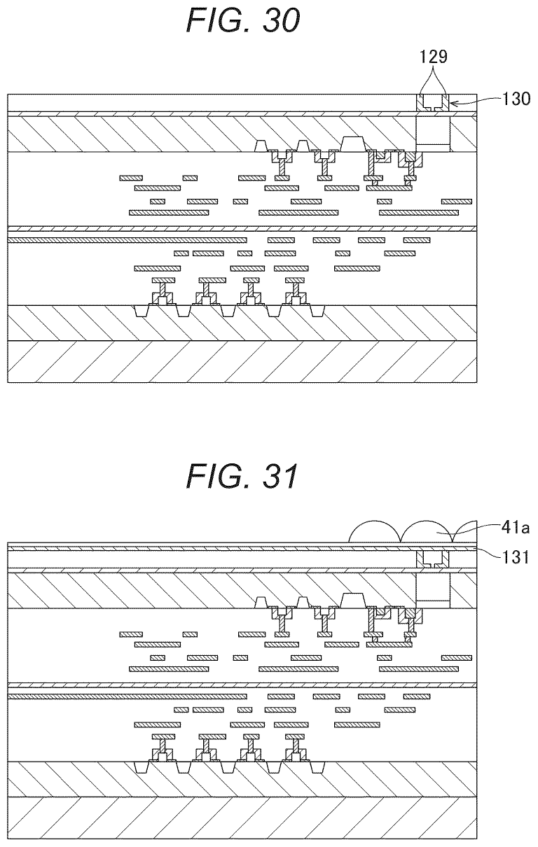

Next, as illustrated in FIG. 29, a light-shielding film groove part 128 is formed. The light-shielding film groove part 128 is formed by providing opening with etching from an upper surface of an insulation film formed on the back surface side of the first semiconductor substrate 122b, and is formed with a depth that, for example, does not reach the first semiconductor substrate 122b. Thereafter, for example, a tungsten film is formed, and a surface thereof is polished by the chemical mechanical polishing (CMP) method. Therefore, as illustrated in FIG. 30, only tungsten 129 in the light-shielding film groove part remains. Therefore, a light shielding film 130 is formed. Thereafter, as illustrated in FIG. 31, a planarization film 131 is formed on the entire surface.

Next, an on-chip lens material is formed in a pixel array region on-the planarization film 131. Thereafter, a resist film for on-chip lenses is formed in a region corresponding to each pixel on an upper part of the on-chip lens material, and etching processing is performed. Therefore, as illustrated in FIG. 31, the first microlenses (on-chip lenses) 41a configuring the second microlens group are formed.

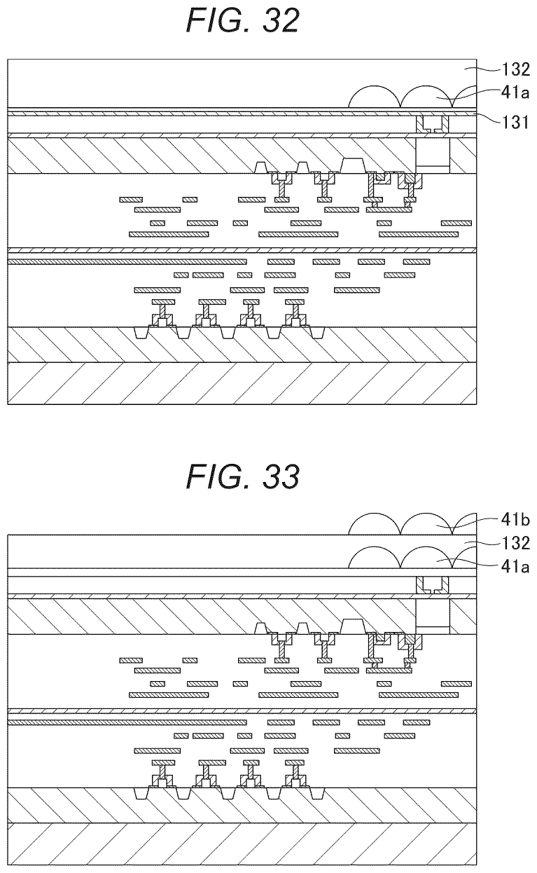

Next, in order to provide the second microlenses (on-chip lenses) configuring the second microlens group at desired intervals, SiO₂ layer 132 is formed as illustrated in FIG. 32.

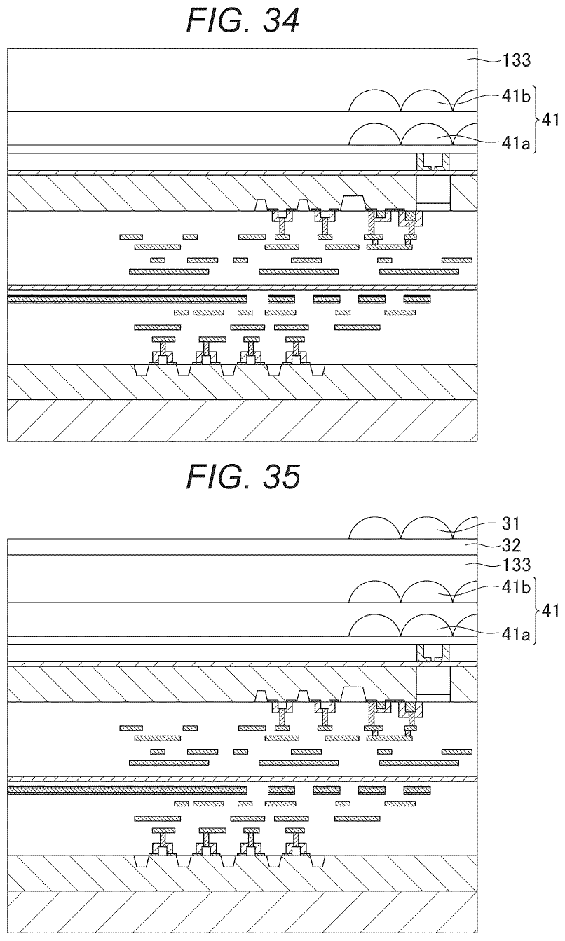

In the same manner as described above, the second on-chip lenses (on-chip lenses) 41b illustrated in FIG. 33 are formed, to form SiO₂ layer 133 illustrated in FIG. 34.

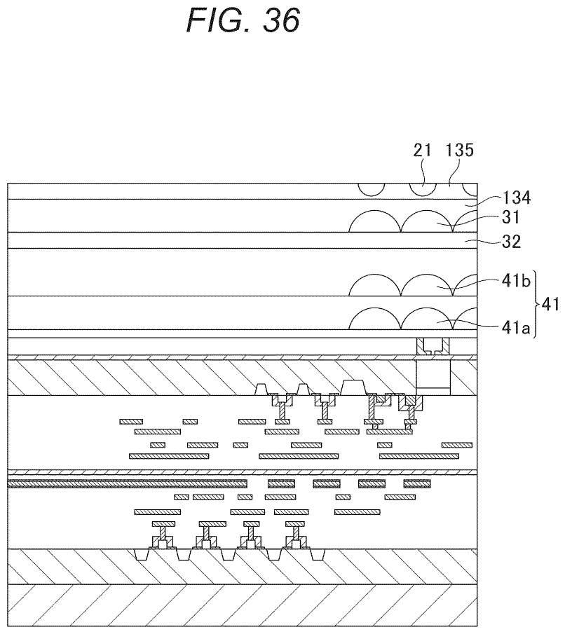

Thereafter, as illustrated in FIG. 35, the optical filter 32 that blocks excitation light and transmits fluorescence is formed on the SiO₂ layer 133. Moreover, in the similar manner as described above, the microlenses 31 (on-chip lenses) configuring the first microlens group are formed, to form SiO₂ layer 134 as illustrated in FIG. 36.

Next, a material 135 of the micro-well array layer is applied, and the micro-well 21 is formed by etching.

Through the manufacturing method including the above steps, the fluorescence detection device 1 is obtained. Through such a manufacturing method, the fluorescence detection device 1 can be obtained by a series of steps including the production process of the solid-state imaging device. For example, by using the existing production facilities for the solid-state imaging device, the fluorescence detection device 1 can be produced.

Therefore, the fluorescence detection device 1 that is inexpensive and has high productivity may be obtained.

Furthermore, the present technology may also adopt the following configurations.

A fluorescence detection device that detects fluorescence of a test object, the fluorescence being generated by irradiation with excitation light, the fluorescence detection device including:
a micro-well array layer having, on an upper surface, micro-wells in a two-dimensional array shape capable of accommodating the test object;
a first detection mechanism provided, below the micro-well array layer, corresponding to each of the micro-wells; and
a solid-state imaging element provided, below the first detection mechanism, corresponding to each of the first detection mechanisms, in which
the first detection mechanism includes a first microlens group having positive power.

The fluorescence detection device described in [1], in which the first detection mechanism includes, in order from the micro-well side,
the first microlens group having positive power
and the optical filter that transmits the fluorescence.

The fluorescence detection device described in [1] or [2], in which the excitation light is obliquely applied to the upper surface of the micro-well array layer.

The fluorescence detection device described in any one of [1] to 0 [3], further including a second detection mechanism provided between the first detection mechanism and the solid-state imaging element, corresponding to each of the first detection mechanisms, in which
the second detection mechanism includes a second microlens group having positive power.

The fluorescence detection device described in [4], in which the second detection mechanism includes, in order from the first detection mechanism side,
the second microlens group having positive power,
and a light shielding film having an opening,
the opening is arranged corresponding to a focal position of the second microlens group.

The fluorescence detection device described in any one of [1] to [5], in which the solid-state imaging element has a light receiving surface of the fluorescence,
and the fluorescence having reached the light receiving surface from the micro-well has an optical axis perpendicular to the light receiving surface.

The fluorescence detection device described in [4] or [5], in which a plurality of combinations of the one second detection mechanism and the one solid-state imaging element arranged in a vertical direction is arranged in parallel in a horizontal direction, corresponding to one micro-well.

The fluorescence detection device described in [4] or [5], in which an air layer is provided between the first detection mechanism and the second detection mechanism.

The fluorescence detection device described in any one of [1] to [8], in which the first microlens group is configured by a diffractive lens or a metalens.

The fluorescence detection device described in any one of [1] to [9], in which the second microlens group is configured by a diffractive lens or a metalens.

The fluorescence detection device described in [2], in which the optical filter blocks the excitation light.

The fluorescence detection device described in [5], in which a diameter of the opening of the light shielding film is 0.0003 mm or more and 0.01 mm or less.

The fluorescence detection device described in [4] or [5], in which a focal length of the second microlens group is 0.0003 mm or more and 3 mm or less.

The fluorescence detection device described in any one of [1] to [13] further includes a light source that applies the excitation light.

A fluorescence detection device plate including:
a micro-well array layer having, on an upper surface, micro-wells in a two-dimensional array shape capable of accommodating the test object; and
a first detection mechanism provided, below the micro-well array layer, corresponding to each of the micro-wells, in which the first detection mechanism includes a first microlens group having positive power.

### REFERENCE SIGNS LIST

1, 1A, 1Aa, 1B, 1C, 1Ca Fluorescence detection device
10 Fluorescence detection device plate
20 Micro-well array layer
21 Micro-well
30 First detection mechanism
31 First microlens group
32 Optical filter
40 Second detection mechanism
41 Second microlens group
42 Light shielding film
43 Opening
50 Substrate
60 Air layer
100 Solid-state imaging device
110 Micro-well array substrate part
120 Sensor part
210 Ceramic package
220 Wire
230 Holding part
240 Protective plate part

1. A fluorescence detection device that detects fluorescence of a test object, the fluorescence being generated by irradiation with excitation light, the fluorescence detection device comprising:
a micro-well array layer having, on an upper surface, micro-wells in a two-dimensional array shape capable of accommodating the test object;
a first detection mechanism provided, below the micro-well array layer, corresponding to each of the micro-wells; and
a solid-state imaging element provided, below the first detection mechanism, corresponding to each of the first detection mechanisms, wherein the first detection mechanism includes a first microlens group having positive power.

2. The fluorescence detection device according to claim 1, wherein the first detection mechanism includes, in order from the micro-well side,
the first microlens group having positive power
and the optical filter that transmits the fluorescence.

3. The fluorescence detection device according to claim 1, wherein the excitation light is obliquely applied to the upper surface of the micro-well array layer.

4. The fluorescence detection device according to claim 1, further comprising a second detection mechanism provided between the first detection mechanism and the solid-state imaging element, corresponding to each of the first detection mechanisms, wherein
the second detection mechanism includes a second microlens group having positive power.

5. The fluorescence detection device according to claim 4, wherein the second detection mechanism includes, in order from the first detection mechanism side,
the second microlens group having positive power,
and a light shielding film having an opening,
the opening is arranged corresponding to a focal position of the second microlens group.

6. The fluorescence detection device according to claim 1, wherein the solid-state imaging element has a light receiving surface of the fluorescence,
and the fluorescence having reached the light receiving surface from the micro-well has an optical axis perpendicular to the light receiving surface.

7. The fluorescence detection device according to claim 4, wherein a plurality of combinations of the one second detection mechanism and the one solid-state imaging element arranged in a vertical direction is arranged in parallel in a horizontal direction, corresponding to one micro-well.

8. The fluorescence detection device according to claim 4, wherein an air layer is provided between the first detection mechanism and the second detection mechanism.

9. The fluorescence detection device according to claim 1, wherein the first microlens group is configured by a diffractive lens or a metalens.

10. The fluorescence detection device according to claim 4, wherein the second microlens group is configured by a diffractive lens or a metalens.

11. The fluorescence detection device according to claim 2, wherein the optical filter blocks the excitation light.

12. The fluorescence detection device according to claim 5, wherein a diameter of the opening of the light shielding film is 0.0003 mm or more and 0.01 mm or less.

13. The fluorescence detection device according to claim 4, wherein a focal length of the second microlens group is 0.0003 mm or more and 3 mm or less.

14. The fluorescence detection device according to claim 1, further comprising a light source that applies the excitation light.

15. A fluorescence detection device plate, comprising: a micro-well array layer having, on an upper surface, micro-wells in a two-dimensional array shape capable of accommodating the test object; and
a first detection mechanism provided, below the micro-well array layer, corresponding to each of the micro-wells, wherein the first detection mechanism includes a first microlens group having positive power.
